(19) United States
(12) Patent Application Publication
(10) Pub. No.: US 2016/0144359 A1
(43) Pub. Date: May 26, 2016

(54) REINFORCED MICROPLATE

(71) Applicant: Corning Incorporated, Corning, NY (US)

(72) Inventors: William Joseph Lacey, North Andover, MA (US); Paul Michael Szlosek, Kennebunk, ME (US); Allison Jean Tanner, Portsmouth, NH (US); Wai Kin Poon, Union City, CA (US)

(21) Appl. No.: 14/950,453

(22) Filed: Nov. 24, 2015

Related U.S. Application Data
(60) Provisional application No. 62/083,362, filed on Nov. 24, 2014.

(51) Int. Cl. B01L 3/00; B01L 9/00

(52) U.S. Cl. CPC B01L 3/5085; B01L 9/523; B01L 2300/0829; B01L 2200/12

(57) ABSTRACT

A reinforced microplate includes a microplate main body having a deck and a plurality of wells, and a reinforcing member. The deck includes a first surface and a second surface. Each well of the plurality of wells extends from the second surface in a substantially perpendicular direction, and each well comprises an opening on the first surface. The reinforcing member is attached to at least one surface of the deck.

This application claims the benefit of priority under 35 U.S.C. §119 of U.S. Provisional Application Ser. No. 62/083362 filed on Nov. 24, 2014 the content of which is relied upon and incorporated herein by reference in its entirety.

### BACKGROUND

1. Field

The present disclosure relates generally to microtiter plates, also known as microplates, and more particularly to reinforced microplates and their methods of manufacture. The reinforced microplates are adapted for use with automated equipment and can withstand thermal cycling with reduced deformation, while providing improved heat transfer.

2. Technical Background

Polymerase chain reaction (“PCR”) processes involve the replication and amplification of genetic material such as DNA and RNA. During this process, segments of DNA are placed in an array of wells sealed at top by tape or a plug for each well. The array of wells is then placed into the heating and cooling block of the thermocycler to start the reaction. The sample can be heated and cooled in very precise and rapid steps in a thermocycling process to create multiple copies of the DNA, thus amplifying the DNA segment in the well. During this thermocycling process, the well plate will see a temperature as high as about 95-100° C.

Because of their ease of handling and relatively low cost, multi-well microplates are often used for sample containment during the PCR process in both industry and academic research. The wells in the microplates can be formatted into 8 well strips or 96, 384, or 1536 well arrays as well as higher and lower density of wells. The 96 well microplate is one of the most common formats for PCR. The wells of the microplate are often connected by a planar deck, which is typically located at the opening of the wells. Microplates may also be used in other research and clinical diagnostic procedures.

A common microplate material is polypropylene, which has few extractables to interfere with DNA or other biological samples or the PCR process. Due to the low working temperature of polypropylene, however, this material can move or become distorted or deformed during or after the thermocycling process. Polypropylene is also prone to higher shrink compared to many engineering molding resins. Deformation may, for example include warping, twisting, shrinking, or other deviations of the planar deck from the original planar conformation. The deformation may interfere with the removal of the strip or microplate from the thermocycling block following the thermocycling process, as deformation from the original planar conformation can result in changes in the overall dimension of the microplate perpendicular to the original plane. The microplate can become stuck in the PCR thermocycling block due to the deformation. The deformation of the microplate can also be a problem if robotic grippers are used to handle the microplate after the thermocycling process.

In order to address the problem of deformation, it may be desirable to use microplates having a thick deck, which may better maintain planar fidelity, i.e., prevent or reduce deformation of the microplate during or after the thermocycling process.

However, traditionally, it is desired to have thin microplate well walls as this may provide increased thermal conductivity, which can result in faster heating and cooling cycle times. This is especially true for microplate wells made from a material having poor thermal conductivity, for example polymers such as polypropylene.

Traditionally, microplates are integrally formed (i.e. deck and wells are all one piece), and thus, conventional molding techniques require that the entire microplate including the deck and wells be the same thickness. Consequently, the thickness of the microplate is traditionally chosen to maintain a degree of balance between good thermal conductivity of the wells and planar fidelity of the deck. Thus, some degree of either or both good thermal conductivity of the wells and planar fidelity of the deck is compromised.

Accordingly, there is a need for a microplate free of the aforementioned shortcomings.

### BRIEF SUMMARY

In accordance with embodiments of the present disclosure, a reinforced microplate is provided. As described in various embodiments herein, the reinforced microplate may include (a) a microplate main body with a deck comprising a first surface and a second surface, and a plurality of wells, and (b) a reinforcing member. The reinforcing member and microplate main body may be attached at least one surface of the deck. The microplate may be formed from a relatively non-rigid material. The reinforcing member may be formed from a material having a higher working temperature and/or a higher overall strength than the material of the microplate, such as glass, copolymer blends, copolymer resins, filled materials such as glass-filled polypropylene and mineral-filled polypropylene, polysulfone, polyphenylene sulfide, polycarbonate, a mixture of acrylonitrile butadiene styrene with polycarbonate, and a mixture of polybutylene terephthalate with polycarbonate.

Also disclosed are methods of forming a reinforced microplate, including providing or forming a microplate main body having a deck comprising a first surface and a second surface and a plurality of wells, providing or forming a reinforcing member, and affixing the reinforcing member to the microplate to provide a reinforced microplate.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A-1C respectively illustrate a perspective view, a cut-away partial perspective view, and a cross-sectional side view of a microplate;

FIG. 2 is a perspective view of a microplate and a reinforcing member according to embodiments;

FIG. 3 is a schematic view showing the assembled reinforced microplate;

FIG. 4 is a cutaway view of the embodiment of FIG. 3 showing the assembled reinforced microplate;

FIG. 5 is a cutaway view of an assembled reinforced microplate according to another embodiment;

FIG. 6 is a perspective view of the bottom of a reinforced microplate according to embodiments; and

FIG. 7 is a cutaway schematic view of the microplate shown in FIG. 6.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

According to various embodiments of the disclosure, reinforced microplates comprising (a) a microplate comprising a main body comprising a deck comprising a first surface and a second surface and a plurality of wells, and (b) a reinforcing member are disclosed. In various embodiments, a microplate main body may comprise a first material and/or a first thickness, and a reinforcing member may comprise a second material and/or a second thickness

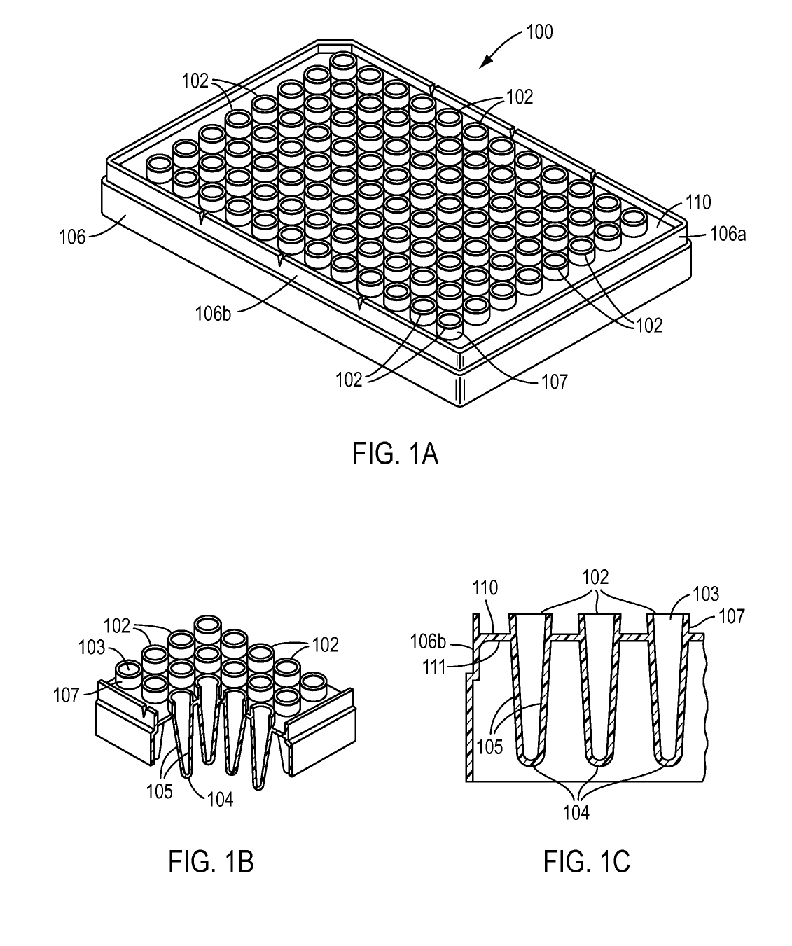

FIGS. 1A-1C, illustrate different views of a microplate main body 100. The microplate main body 100 includes a deck 106 and a plurality of wells 102. The deck 106 has a first surface and a second surface. In various embodiments, the first surface may be a top surface 110, and the second surface may be a bottom surface 111, and vice versa. However, for ease of reference only, and without intending to limit the scope, the deck 106 will be described with reference to the first surface as the top surface 110, and the second surface as the bottom surface 111.

According to various embodiments, the deck 106 may have a substantially planar top surface 110 and a bottom surface 111 defining a deck thickness. The thickness of the deck 106 is defined as the distance between the top surface 110 and the bottom surface 111 along a line substantially perpendicular to a major plane of the top surface 110.

The top surface 110 and/or the bottom surface 111 of the deck 106 can be any suitable geometrical or freeform shape. Nonlimiting examples of geometric shapes include polygonal, triangular, quadrangular, rectangular, square, trapezoidal, parallelogrammatic, rhomboidal, pentagonal, hexagonal, heptagonal, octagonal, nonagonal, decagonal, circular, ovoid, ellipsoid, curvilinear polygonal, and combinations thereof. In some embodiments, the shape of the top surface 110 and/or the bottom surface 111 of the deck 106 may depend, for example, on the desired arrangement of the wells and/or a configuration of a particular thermocycler to be employed.

In various embodiments, the top surface 110 and/or the bottom surface 111 of the deck 106 may optionally include at least one feature providing an asymmetry to the deck 106 for purposes of aligning the microplate main body 100 within another device, for example a gripping device, a handling system, a thermocycler, or a storage device. According to certain embodiments, the at least one asymmetric feature is chosen from cutouts, protrusions, and combinations thereof. In one exemplary embodiment, the top surface 110 and/or the bottom surface 111 of the deck 106 has a substantially geometric shape and includes at least one cutout and/or protrusion.

The deck 106 may optionally include an apron 106a extending along a periphery of the top surface 110. In some embodiments, at least a portion of the apron 106a extends substantially perpendicular to the top surface 110. In other embodiments, at least a portion of the apron 106a extends at an angle greater than or less than 90° to the top surface 110 of the deck 106. In some embodiments, the apron 106a can accommodate a skirt of a microplate cover. In other embodiments, the deck does not include an apron 106a.

The apron 106a may optionally include an outer rim 106b. In various embodiments, at least a portion of the outer rim 106b extends along a periphery of the free edge of the apron 106a. In other embodiments, the deck does not include an outer rim 106b.

Each well 102 of the plurality of wells includes a well opening 103, a well bottom 104, and a well wall 105 located between the well opening 103 and the well bottom 104. In various embodiments, the well opening 103 of at least one well 102 of the microplate main body 100 is located at or adjacent to the top surface 110 of the deck 106. In some embodiments, the well opening 103 of at least one well 102 is located at the top surface 110 of the deck 106. In other embodiments, the well opening 103 of at least one well 102 is located above the top surface 110 of the deck 106, as indicated by a ridge 107 surrounding the periphery of the well opening 103 and extending above the top surface 110 of the deck 106, as shown in FIGS. 1A-1C. In some embodiments, the ridge 107 helps to provide a seal for the well 102 during a thermocycling process. In some embodiments, at least one well 102 of the microplate main body 100 does not include a ridge 107.

The microplate main body 100 may include any number of wells 102, including at least 2 wells, at least 8 wells, at least 50 wells, at least 96 wells, at least 200 wells, at least 500 wells, or at least 1000 wells. Nonlimiting examples of the number of wells 102 include 8, 96, 384, or 1536.

The wells 102 may be arranged in any pattern. In various embodiments, the wells 102 are arranged in a regular array of rows and columns. In some embodiments, the wells 102 in each row and/or column are substantially aligned with wells 102 in adjacent rows and/or adjacent columns. In other embodiments, the wells 102 in each row and/or column are offset from wells 102 in adjacent rows and/or adjacent columns. In some embodiments, at least a portion of the wells 102 are arranged in at least one linear row and/or column. In other embodiments, at least a portion of the wells 102 are arranged in at least one nonlinear row and/or column. In other embodiments, at least a portion of the wells 102 are arranged in at least one curved row and/or column. In some embodiments, at least a portion of the wells 102 are arranged to form a repeating pattern. In other embodiments, at least a portion of the wells 102 do not form a repeating pattern. The embodiments illustrated in FIGS. 1A and 1B, for example, show a microplate main body 100 having a regular array of wells 102, where the wells 102 are arranged in linear rows and columns to form a repeating pattern. The wells 102 in each row and column are substantially aligned with wells 102 in adjacent rows and adjacent columns in the embodiments shown in FIGS. 1A and 1B.

The well opening 103 can have any suitable geometrical or freeform shape. Nonlimiting examples of geometric shapes include polygonal, triangular, quadrangular, rectangular, square, trapezoidal, parallelogrammatic, rhomboidal, pentagonal, hexagonal, heptagonal, octagonal, nonagonal, decagonal, circular, ovoid, ellipsoid, curvilinear polygonal, and combinations thereof. In various embodiments, at least one well 102 has a well opening 103 having a shape in common with at least one other well of the plurality of wells. In some embodiments, each well 102 has a well opening 103 having a same shape as every other well of the plurality of wells. In other embodiments, each well 102 of the plurality of wells has a well opening 103 having a unique shape. In the embodiments illustrated in FIGS. 1A and 1B, for example, each well 102 has a well opening 103 that is substantially circular.

The wells 102 may have any suitable shape configured to contain a desired fluid volume. In various embodiments, the shape of the well 102 is defined by the well wall 105. Nonlimiting examples of shapes includes conical, frustoconical, rounded conical, right or oblique pyramidal, right or oblique frustopyramidal, cylindrical, cylindrical with a rounded end, right or oblique prism shaped, uniform or nonuniform prism shaped, bullet-shaped, and combinations thereof. In various embodiments, at least one well 102 has at least one plane of symmetry. In some embodiments, the at least one plane of symmetry includes a major axis of the well 102. In some embodiments, at least one well 102 is radially symmetric about the major axis of the well 102. Other embodiments include at least one well 102 that lacks a plane of symmetry. In some embodiments, the well 102 has a cross-section taken along a plane substantially perpendicular to the major axis of the well that is substantially the same shape throughout the depth of the well 102. In other embodiments, the well 102 has a cross-section taken along a plane substantially perpendicular to the major axis of the well that varies throughout the depth of the well 102. In some embodiments, the well 102 has a circular cross-section taken along a plane substantially perpendicular to the major axis of the well, as shown in FIG. 1B for example.

Nonlimiting methods for forming the microplate main body 100 include injection molding, injection compression molding, vacuum formation with a female mold and a male plug assist, and combinations thereof.

In various exemplary embodiments, the microplate main body 100, including but not limited to the well walls, may be formed from a transparent material. As used herein, “transparent” means at least 60% transparency (e.g., at least 60, 65, 70, 75, 80, 82, 84, 86, 88, 90, 92, 94, 96, 98, 99 or 100% transparency) for a given wavelength or over a range of wavelengths. In certain embodiments, the well walls 105 are transparent to visible light (i.e., over the wavelength range of 390 to 700 nm). In various embodiments, the well walls 105 are transparent to ultraviolet and/or near-infrared radiation (i.e., over the respective wavelength ranges of 100 to <390 nm and >700 to 2500 nm).

In at least certain embodiments, the microplate main body 100, including but not limited to the well walls 105, may comprise a material that is characterized by low background fluorescence. Fluorescence is a form of absorbed energy that is reradiated at a lower energy, often as light. The amount of fluorescence (or lack thereof) from reinforced microplates is a factor in their implementation with, for example, analytical spectroscopy, polarization and imaging, including point-of-care (POC) in vitro diagnostic tests, and other life-sciences analytics such as cellular flow cytometry.

The microplate main body 100 may, for example, comprise a polymeric material. In various embodiments, the polymeric material has at least one characteristic chosen from being biologically inert, being chemically inert, having low biological reactivity, being thermoplastic, being moldable, being remoldable, having low extractables, being optically transparent, being optically translucent, being IR transparent, being UV transparent, and combinations thereof. In some embodiments, the microplate main body 100 is formed from polycarbonate, polystyrene, polypropylene, polyvinyl chloride, polyethylene terephthalate, cyclo-olefins, or combinations thereof, which are thermoplastic, moldable, remoldable, chemically inert, optically translucent or transparent, and have low extractables.

However, as discussed above, such materials may have low working temperatures, and thus the microplate main body 100 may deform or undergo other undesirable effects during or after the thermocycling process. Deformation may include warping, twisting, or other deviations from the original planar conformation of the top surface 110 of the deck 106.

In addition, some polymeric materials, for example polypropylene, may strain in response to thermally-induced stress. Some polymeric materials, including polypropylene, can harbor residual stress from nonuniform cooling following a molding process, for example an injection molding process. The thermally-induced stress and/or the residual stress may result in deformation of the microplate during or after the thermocycling process.

As a result of the deformation of the microplate 100 during thermal cycling, it may be difficult to remove a microplate main body 100 from the thermocycler, as deformation from the original planar conformation can result in increases in the overall dimension of the microplate perpendicular to the original plane. Notably, as the number of wells 102 (and the overall size) of the microplate 100 increases, the force required to remove the microplate 100 from the thermocycler may increase, which may further deform the microplate. Moreover, robotic handling systems may have difficulty manipulating and/or removing the deformed microplate main body 100 from the thermocycler. In addition, the deck 106 may thermally degrade as a result of the thermal cycling. Such degradation may further contribute to warping or twisting of the microplate.

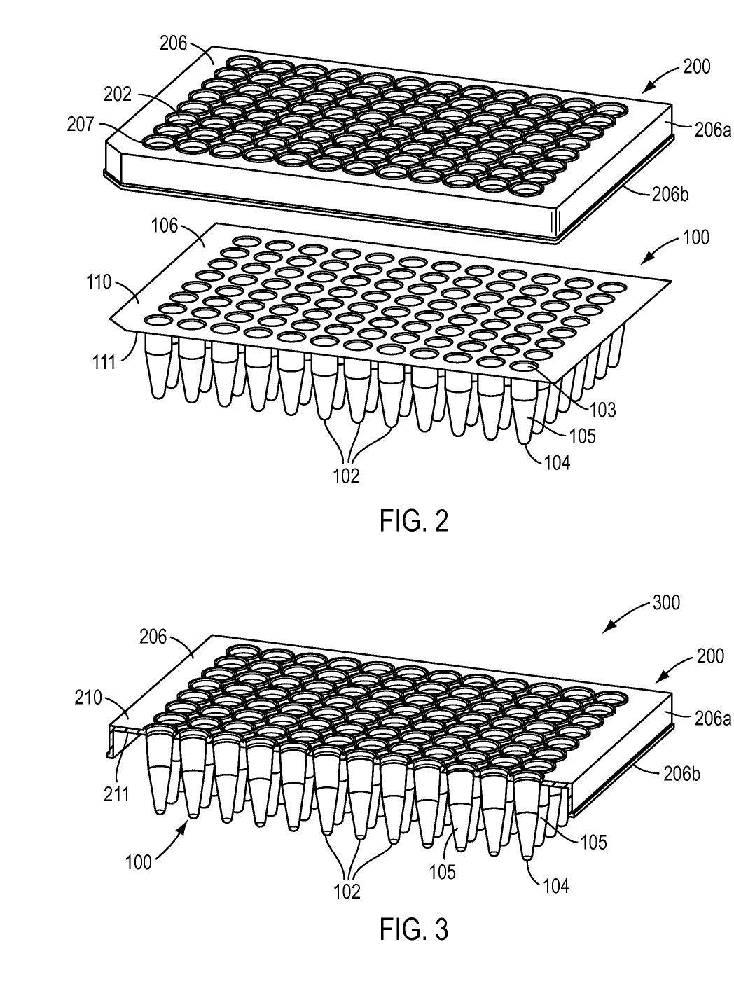

Accordingly, as described herein, with reference to FIGS. 2-7, the microplate main body 100 may be reinforced by a reinforcing member 200. The use of a reinforced microplate 300 may, according to at least some embodiments, facilitate handling of the microplate by a scientist or robotic handling system, for example during removal the microplate from the thermocycler after completion of the PCR process.

The reinforcing member 200 may comprise a second material that has a higher working temperature than the first material of the microplate main body 100, and/or a second material that has a higher overall strength and/or physical toughness than the first material of the microplate main body 100. However, in alternate embodiments, the reinforcing member 200 may comprise a second material that has the same as or lower working temperature than the first material of the microplate main body 100. The reinforced microplate 300 can improve thermal conductivity and/or planar fidelity in various embodiments.

According to various embodiments, reinforcing member 200 may comprise a polymeric material. In at least some embodiments, the reinforcing member 200 comprises the same material as the microplate main body 100. In other embodiments, the reinforcing member 200 comprises a different material than the microplate main body 100. In various exemplary embodiments, the reinforcing member 200 comprises a material chosen from glass, copolymer blends, copolymer resins, filled materials such as glass-filled polypropylene and mineral-filled polypropylene, polysulfone, polyphenylene sulfide, polycarbonate, a mixture of acrylonitrile butadiene styrene with polycarbonate, and a mixture of polybutylene terephthalate with polycarbonate. In some embodiments, the reinforcing member 200 is formed from a liquid polymer or polymer precursor. In some embodiments, the reinforcing member is formed from a solid polymer or polymer precursor. The reinforcing member 200 may be formed from a transparent material and/or a material characterized by low background fluorescence, according to at least certain embodiments.

A nonlimiting method for forming the reinforcing member 200 includes injection molding.

With reference to FIG. 2, a reinforcing member 200 comprises a reinforcing deck 206 and a plurality of openings 202. In FIG. 2, each opening 202 of the plurality of openings corresponds to a well opening 103 of the plurality of wells 102 of the microplate main body 100, although such correspondence is not required. The term “correspond” as used herein is meant to indicate a match in spatial location and/or number.

In some embodiments, the reinforcing deck 206 has a substantially planar top surface 210 and a bottom surface 211 defining a deck thickness. The thickness of the reinforcing deck 206 is defined as the distance between the top surface 210 and the bottom surface 211 along a line substantially perpendicular to a major plane of the top surface 210. In some embodiments, the bottom surface 211 is substantially planar. In other embodiments, the top surface 210 and/or the bottom surface 211 of the reinforcing deck 206 is not substantially planar. In some embodiments, the thickness of the reinforcing deck 206 is substantially uniform throughout the reinforcing deck 206. In other embodiments, the thickness of the deck is variable throughout the reinforcing deck 206. In yet other embodiments, the reinforcing deck 206 has regions of higher deck thickness and regions of lower deck thickness.

In some embodiments, the reinforcing member 200 has a thickness that is greater than a thickness of the microplate main body 100. In other embodiments, the reinforcing member 200 has a thickness that is less than or substantially equal to the thickness of the microplate main body 100.

The top surface 210 and/or the bottom surface 211 of the reinforcing deck 206 can be any suitable geometrical or freeform shape. Nonlimiting examples of geometric shapes include polygonal, triangular, quadrangular, rectangular, square, trapezoidal, parallelogrammatic, rhomboidal, pentagonal, hexagonal, heptagonal, octagonal, nonagonal, decagonal, circular, ovoid, ellipsoid, curvilinear polygonal, and combinations thereof. In some embodiments, the shape of the top surface 210 and/or the bottom surface 211 of the reinforcing deck 206 may depend, for example, on the desired arrangement of the openings and/or a configuration of a particular thermocycler to be employed.

In some embodiments, the reinforcing deck 206 may have substantially the same planar dimensions and/or substantially the same planar shape as the deck 106. In other words, the reinforcing deck 206 and the deck 106 may be substantially congruent. For example, in the embodiment shown in FIG. 2, the top surface 210 of reinforcing deck 206 of the reinforcing member 200 has substantially the same planar dimensions and planar shape as the top surface 110 of the deck 106 of the microplate main body 100. In other embodiments, however, at least one of the planar dimensions and planar shape of the reinforcing deck 206 of the reinforcing member 200 may be different from at least one of the planar dimensions and planar shape of the deck 106 of the microplate main body 100.

The reinforcing deck 206 may optionally include an apron 206a extending along a periphery of the top surface 210. In some embodiments, at least a portion of the apron 206a extends substantially perpendicular to the top surface 210. In other embodiments, at least a portion of the apron 206a extends at an angle greater than or less than 90° to the top surface 210 of the reinforcing deck 206. In other embodiments, the deck does not include an apron 206a.

In some embodiments, the apron 206a may have substantially the same dimensions and/or substantially the same shape as an apron 106a. In other words, dimensions and/or shape of the apron 206a of the reinforcing member 200 and the apron 106a of the microplate main body 100 are congruent. In other embodiments, at least one of the size and shape of the apron 206a of the reinforcing member is different from at least one of the size and shape of the apron 106a of the microplate main body 100.

In some embodiments, the reinforcing deck 206 includes an apron 206a, and the deck 106 does not include an apron 106a. In other embodiments, the reinforcing deck 206 does not include an apron 206a, and the deck 106 includes an apron 106a. In the embodiment shown in FIG. 2, the reinforcing deck 206 includes an apron 206a, and the deck 106 does not include an apron 106a, and the apron 206a of the reinforcing member 200 fits substantially around the perimeter of the deck 106 of the microplate main body 100.

The apron 206a may optionally include an outer rim 206b. In various embodiments, at least a portion of the outer rim 206b extends substantially perpendicular to the top surface 210. In other embodiments, at least a portion of the outer rim 206b extends at an angle greater than or less than 90° to the top surface 210 of the reinforcing deck 206. In other embodiments, the deck does not include an outer rim 206b.

The reinforcing deck 206 as shown in FIGS. 2 and 3 has a rectangular shape and includes an apron 206a and a top planar surface 210 extending in part between the apron 206a and the openings 202. The reinforcing deck 206 as shown in FIGS. 2 and 3 further includes an outer rim 206b and a substantially planar bottom surface 211 (211 not shown in FIG. 2).

The reinforcing member 200 also includes at least one opening 202. In some embodiments, the reinforcing member 200 includes a plurality of openings 202. The reinforcing member 200 may include any number of openings, including at least 2 openings, at least 8 openings, at least 50 openings, at least 96 openings, at least 200 openings, at least 500 openings, or at least 1000 openings. Nonlimiting numbers of openings 202 included in an exemplary reinforcing member 200 include 8, 96, 384, or 1536 openings 202.

The reinforcing member 200 may, according to certain embodiments, have the same number of openings 202 as the number of wells 102 in the microplate main body 100. In other embodiments, the reinforcing member has fewer openings 202 than the number of wells 102 in the microplate main body 100. In yet further embodiments, the reinforcing member has more openings 202 than the number of wells 102 in the microplate main body 100.

The openings 202 may be arranged in any pattern. In various embodiments, the openings 202 are arranged in a regular array of rows and columns. In some embodiments, the openings 202 in each row and/or column are substantially aligned with openings 202 in adjacent rows and/or adjacent columns. In other embodiments, the openings 202 in each row and/or column are offset from openings 202 in adjacent rows and/or adjacent columns. In some embodiments, at least some portion of the openings 202 are arranged in at least one linear row and/or column In other embodiments, at least some portion of the openings 202 are arranged in at least one nonlinear row and/or column. In other embodiments, at least some portion of the openings 202 are arranged in at least one curved row and/or column. In some embodiments, at least some portion of the openings 202 are arranged to form a repeating pattern. In other embodiments, at least some portion of the openings 202 do not form a repeating pattern. The embodiments illustrated in FIGS. 2 and 3 show a reinforcing member 200 having a regular array of openings 202, where the openings 202 are arranged in linear rows and columns to form a repeating pattern. The openings 202 in each row and column are substantially aligned with openings 202 in adjacent rows and adjacent columns in the embodiment shown in FIGS. 2 and 3.

The plurality of openings 202 of the reinforcing member 200 may have substantially the same arrangement or pattern as the plurality of wells 102 of the microplate main body 100 in some embodiments. In other embodiments, the plurality of openings 202 of the reinforcing member 200 have a different arrangement or pattern from the plurality of wells 102 of the microplate main body 100. In the embodiments shown in FIGS. 2 and 3, for example, the plurality of openings 202 of the reinforcing member 200 have substantially the same pattern as the plurality of wells 102 of the microplate main body 100.

The opening 202 can have any suitable geometrical or freeform shape. Nonlimiting examples of geometric shapes include polygonal, triangular, quadrangular, rectangular, square, trapezoidal, parallelogrammatic, rhomboidal, pentagonal, hexagonal, heptagonal, octagonal, nonagonal, decagonal, circular, ovoid, ellipsoid, curvilinear polygonal, and combinations thereof. In various embodiments, at least one opening 202 has a shape in common with at least one other opening of the plurality of openings. In some embodiments, each opening 202 has a same shape as each other opening of the plurality of openings. In other embodiments, each opening 202 of the plurality of openings has a unique shape. In the embodiments illustrated in FIGS. 2 and 3, each opening 202 is substantially circular.

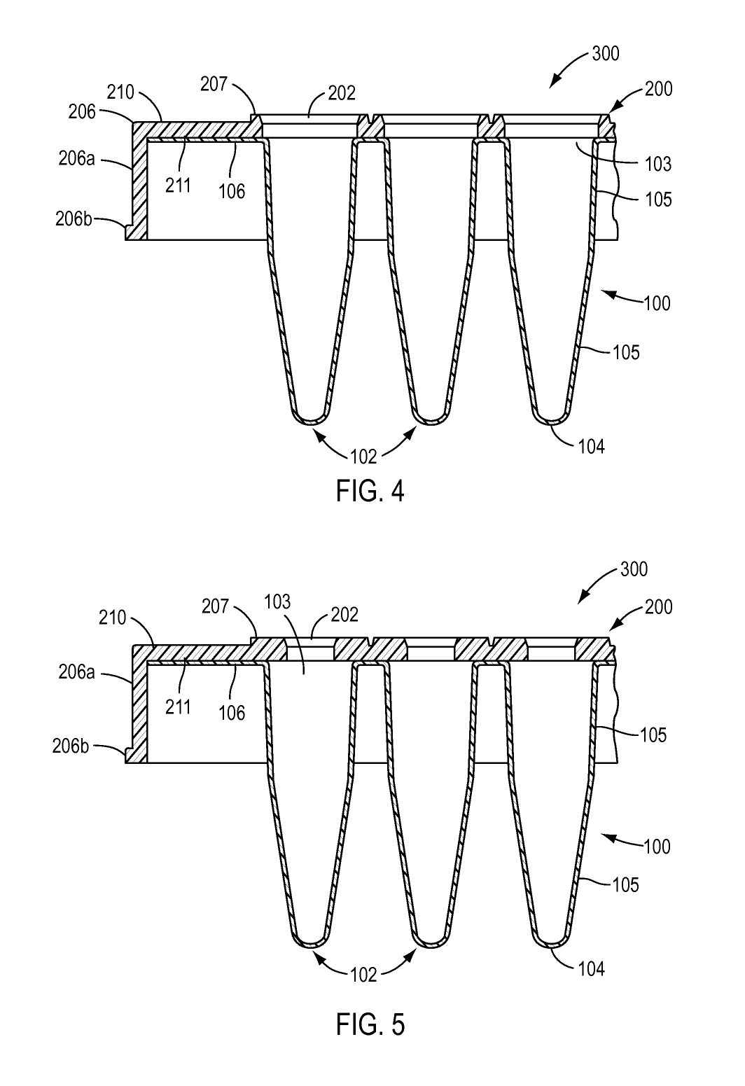

In some embodiments, at least one opening 202 of the reinforcing member 200 may have substantially the same size and/or substantially the same shape as the well opening 103 of a corresponding well 102 in the microplate main body 100, as shown in FIG. 4. In other embodiments, at least one of the size and shape of at least one opening 202 of the reinforcing member 200 is different from at least one of the size and shape of the well opening 103 of a corresponding well 102 of the microplate main body 100. In the embodiment shown in FIG. 5, each opening 202 of the reinforcing member 200 has substantially the same shape as the well opening 103 of each well 102 of the microplate main body 100, and each opening 202 is smaller in diameter than the well opening 103 of each well 102. In various embodiments, a smaller opening can help reduce evaporation and/or cross contamination during the thermocycling process and/or during handling. In some embodiments, a smaller opening can facilitate easier molding of the part due to lower pressure drops caused by the second material traveling around the openings 202. According to various embodiments, smaller openings 202 can result in more material in the reinforcing member 200, which can increase the strength in the reinforcing member. A stronger reinforcing member 200 may better reduce the amount of warping or twisting of the reinforced microplate 300 during use.

In various embodiments, at least one ridge 207 extends from a periphery of at least one opening 202 at the top surface 210 of the reinforcing deck 206. In some embodiments, the ridge 207 helps to provide a seal for the opening 202 and the well 102 during the thermocycling process. In other embodiments, the reinforcing member 200 does not include any projections extending from a periphery of at least one opening 202 at the top surface 210 of the reinforcing deck 206.

In some embodiments, at least one projection (not shown) extends from a periphery of at least one opening 202 at the bottom surface 211 of the reinforcing deck 206. In certain embodiments, the projection is configured to extend into a corresponding well 102 of the microplate main body 100 when the reinforced microplate 300 is assembled. In other embodiments, the reinforcing member 200 does not include any projections extending from a periphery of at least one opening 202 at the bottom surface 211 of the reinforcing deck 206.

When the reinforced microplate 300 is assembled, the reinforcing member 200 is attached to at least one surface of the microplate main body 100. For example, the reinforcing member 200 may be attached to the top surface 110 and/or the bottom surface 111 of the microplate main body 100. According to certain embodiments, the reinforcing member 200 and microplate main body 100 may be configured to nest with one another when the reinforced microplate 300 is assembled. As used herein, “configured to nest with one another” is meant to indicate that the deck 106 and reinforcing deck 206 are in contact or close proximity, and at least one well 102 of the microplate main body 100 extends through at least one opening 202 in the reinforcing member 200. In at least one embodiment, “configured to nest with one another” indicates that the dimensions and shape of the deck 106 and reinforcing deck 206, and the number and arrangement of wells 102 and openings 202, are the same or sufficiently similar such that when the reinforced microplate 300 is assembled, the deck 106 and reinforcing deck 206 are in contact, and each well 102 is inserted through each corresponding opening 202.

When the reinforcing member 200 and microplate main body 100 are adjacent, such as when the reinforced microplate 300 is assembled, a periphery of at least one well 102 may, according to at least certain embodiments, extend through an opening 202 such that the opening 103 of the at least one well 102 is at or extends from the top surface 210 of the reinforcing member 200. In some embodiments, the well wall 105 of at least one well 102 is continuous from at or above the top surface 210 of the reinforcing member 200 to the well bottom 104.

When the reinforced microplate 300 is assembled, the reinforcing member 200 may optionally be attached to the microplate main body 100, for example by any suitable method. Non-limiting methods for attaching the reinforcing member 200 to the microplate main body 100 include over-molding, welding, riveting, friction fit, snap fit, or combinations thereof. The reinforcing member 200 can be formed and/or held in place by over-molding, ultrasonic welding, hotplate welding or laser welding. If the microplate deck 106 and the reinforcing member 200 are made from incompatible bonding materials, the reinforcing member can be riveted, friction fit, or snap fit into place. When in place, the reinforcing member 200 may, according to at least certain embodiments, minimize distortion or warping of the reinforced microplate 300 due to thermocycling.

In some embodiments, the microplate main body 100 and the reinforcing member 200 are configured such that, when engaged with one another, the microplate main body 100 and the reinforcing member 200 can be separated only when a force greater than a threshold force is applied.

The reinforced microplate 300 may be assembled in some embodiments by forming the reinforcing member 200 over the microplate main body 100, for example, by an over-molding or co-molding process. In other embodiments, the microplate main body 100 is formed over the reinforcing member 200, for example, by an over-molding or co-molding process. According to further embodiments, the microplate main body 100 and/or the reinforcing member 200 may include at least one first fixing structure configured to engage with at least one second fixing structure to keep the reinforcing member 200 engaged with the microplate main body 100. Non-limiting examples of the first fixing structure and/or the second fixing structure include tabs, posts, snaps, rivets, threaded posts, slots, holes, threaded holes, rims, ridges, or combinations thereof.

According to various embodiments, the reinforcing member 200 and the microplate main body 100 are independently formed and subsequently assembled, for example by a welding, riveting, adhesive, friction fit, or snap fit step, to form a reinforced microplate 300.

In some embodiments, at least a portion of the reinforcing member 200 is welded to at least a portion of the microplate main body 100. According to further embodiments, at least a portion of the bottom surface 211 of the reinforcing member 200 is welded to at least a portion of the top surface 110 of the microplate main body 100. In some embodiments, at least a portion of a periphery of at least one well 102 is welded to at least a portion of the bottom surface 211 of the reinforcing member 200. In certain embodiments, at least a portion of a periphery of at least one well 102 is welded to at least a portion of a periphery of at least one corresponding opening 202. In other embodiments, at least a portion of a periphery of at least one opening 202 is welded to at least a portion of the top surface 110 of the microplate main body 100. In some embodiments, the entire periphery of at least one well 102 is welded to the entire periphery of at least one opening 202. In some embodiments, the entire periphery of at least one well 102 is welded to a corresponding portion of the bottom surface 211 of the reinforcing member 200. According to some embodiments, the entire periphery of at least one opening 202 is welded to a corresponding portion of the top surface 110 of the microplate main body 100.

According to various embodiments, the welding may be achieved by ultrasonic, hotplate, or laser welding.

In various embodiments, if a hot plate or ultrasonic welding is chosen as the assembly method, the reinforcing member 200 may optionally comprise a glass, mineral filled polypropylene or a copolymer resin. A filled polypropylene or a copolymer blend resin may create a stronger material for the reinforcing member 200 in some embodiments. By using a material that contains polypropylene or a blend thereof in the reinforcing member 200, the reinforcing member 200 may more easily bond to the microplate main body 100 by welding.

FIG. 4 shows a reinforced microplate 300 wherein the microplate main body 100 is attached to the reinforcing member 200 by an integral weld bead along a periphery of each well 102 and opening 202.

At least one first fixing structure may be formed in the microplate main body 100 and/or the reinforcing member 200 to provide a friction fit or snap fit or other similar securing mechanism between the reinforcing member and the microplate main body. In various embodiments, at least one second fixing structure configured to engage with the at least one first fixing structure may be formed in the microplate main body 100 and/or the reinforcing member 200. In some embodiments, a plurality of first fixing structures and a plurality of second fixing structures are chosen. By way of example, at least one first fixing structure is formed in the microplate main body 100 and at least one second fixing structure configured to engage with the at least one first fixing structure is formed in the reinforcing member 200. As a further example, at least one first fixing structure is formed in the reinforcing member 200 and at least one second fixing structure configured to engage with the at least one first fixing structure is formed in the microplate main body 100. As yet a further example, at least one first fixing structure is formed in the reinforcing member 200 and at least one second fixing structure configured to engage with the at least one first fixing structure is formed in the microplate main body 100, and at least one first fixing structure is formed in the microplate main body 100 and at least one second fixing structure configured to engage with the at least one first fixing structure is formed in the reinforcing member 200.

In some embodiments, the first fixing structures may be formed on the bottom surface 211 of the reinforcing member 200, and the second fixing structures may be formed on the top surface 110 of the microplate main body 100. In other embodiments, the second fixing structures may be formed on the bottom surface 211 of the reinforcing member 200, and the first fixing structures may be formed on the top surface 110 of the microplate main body.

In certain embodiments, the first fixing structures may extend partially through or completely through the second fixing structures.

According to certain embodiments, the first fixing structures and/or second fixing structures are not visible from the top surface 210 of the reinforcing member, the bottom surface 111 of the microplate main body, or both. In other embodiments, the first fixing structures and/or second fixing structures are visible from the top surface 210 of the reinforcing member, the bottom surface 111 of the microplate main body, or both.

According to various embodiments, at least a portion of the apron 206a of the reinforcing member 200 engages with at least a portion of the microplate main body 100 to form a friction fit and/or a snap fit. In some embodiments, at least a portion of the apron 206a of the reinforcing member 200 engages with at least a portion of the deck 106 of the microplate main body 100 to form a friction fit and/or a snap fit when the reinforced microplate 300 is assembled.

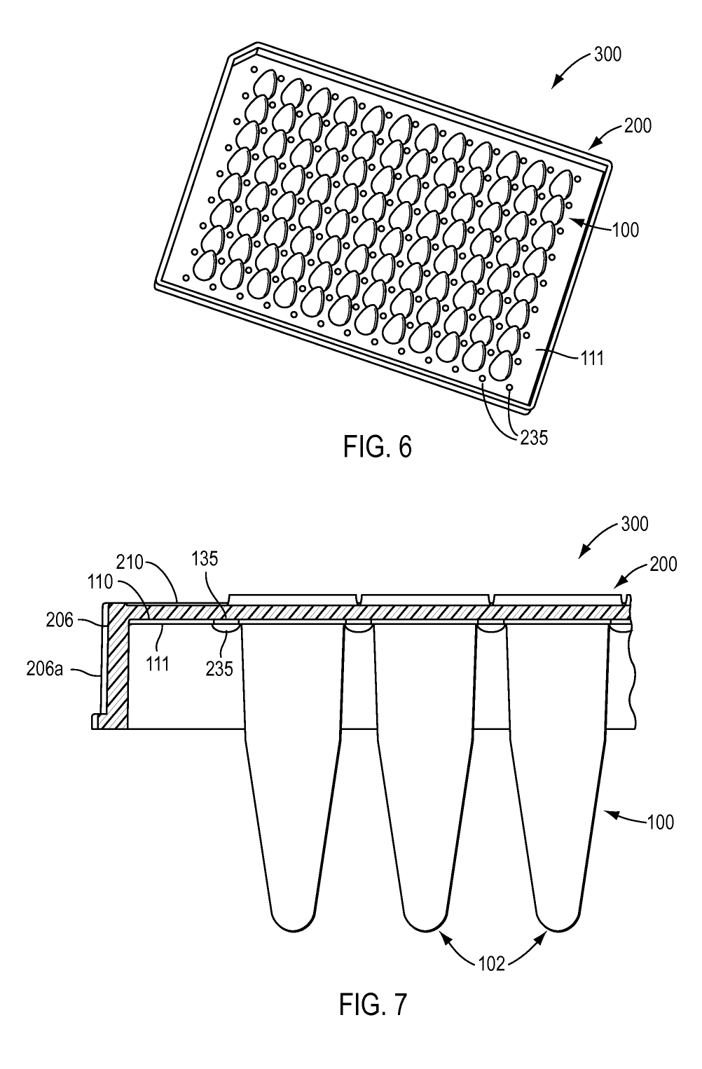

FIGS. 6 and 7 illustrate an example of a reinforced microplate 300 where the microplate main body 100 and the reinforcing member 200 are molded in separate processes, and then assembled by riveting or swaging a plurality of first fixing structures 235, for example a plurality of locking pins, on reinforcing member 200 through a plurality of corresponding second fixing structures 135, for example a plurality of corresponding holes, on the microplate main body 100 to attach the reinforcing member 200 to the top planar surface 110 of the microplate main body 100. In the illustrated embodiment, first fixing structures 235 are formed on the bottom surface 211 of the reinforcing member 200. The first fixing structures 235 are inserted into the corresponding second fixing structures 135 through the top planar surface 110 of the microplate main body 100. The first fixing structures 235 extend through the deck 106 and protrude from the bottom surface 111.

In various embodiments, at least one first fixing structure 235 is configured to engage with a corresponding at least one second fixing structure 135 to attach the reinforcing member 200 to the microplate main body 100 to form a reinforced microplate 300. In some embodiments, the at least one first fixing structure 235 is configured such that, when engaged with the at least one second fixing structure 135, the at least one first fixing structure 235 can be removed from the at least one second fixing structure 135 only when a force greater than a threshold force is applied.

In some embodiments, the first fixing structures 235 are configured to provide a friction fit or a snap fit when engaged in the second fixing structures 135.

According to some embodiments, the at least one first fixing structure 235 is reformed to prevent the at least one first fixing structure 235 from being easily removed from the corresponding second fixing structure 135. In some embodiments, the reforming process is irreversible, and the first fixing structure 235 is permanently deformed and the reinforcing member 200 and microplate main body 100 may not be separated without damaging the first fixing structure. In other embodiments, the reforming process is reversible and the reinforcing member 200 and microplate main body 100 may subsequently be separated without damaging the first fixing structure. In various embodiments, the first fixing structure 235 is reformed in a riveting step using heat staking, cold staking, or ultrasonic staking to swage the first fixing structure 235, for example a locking pin, to the shape as shown in FIGS. 6 and 7. In other embodiments, the first fixing structure 235 is formed in the corresponding second fixing structure 135 in an over-molding or co-molding step.

As used herein, the singular forms “a,” “an” and “the” include plural referents unless the context clearly dictates otherwise. Thus, for example, reference to a “well” includes examples having two or more such “wells” unless the context clearly indicates otherwise.

As used herein, the term “at least one” means “one or more,” for example one, two, several, many, or all.

As used herein, the term “and/or” means at least one of the options, but can include more than one of the options, for example one, two, several, many, or all of the options.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” to function in a particular way. In this respect, such a component is “configured” to embody a particular property, or function in a particular manner, where such recitations are structural recitations as opposed to recitations of intended use. More specifically, the references herein to the manner in which a component is “configured” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a microplate comprising polypropylene include embodiments where a microplate consists of polypropylene and embodiments where a microplate consists essentially of polypropylene.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A reinforced microplate comprising:
(a) a microplate main body comprising:
(1) a deck comprising a first surface and a second surface, and
(2) a plurality of wells,
wherein each well of the plurality of wells extends from the second surface in a substantially perpendicular direction, and
wherein each well comprises an opening on the first surface; and
(b) a reinforcing member attached to at least one surface of the deck.

2. The reinforced microplate according to claim 1, wherein the reinforced microplate is a PCR plate.

3. The reinforced microplate according to claim 1, wherein the reinforcing member comprises a plurality of holes corresponding to the plurality of wells.

4. The reinforced microplate according to claim 3, wherein at least one hole of the plurality of holes comprises a diameter that is substantially equal to, less than, or greater than the diameter of the opening of a corresponding well of the plurality of wells.

5. The reinforced microplate according to claim 3, wherein at least a portion of a periphery of at least one hole of the plurality of holes is attached to at least a portion of a periphery of the opening of a corresponding well of the plurality of wells.

6. The reinforced microplate according to claim 3, wherein at least a portion of the deck at a periphery of the opening of at least one well of the plurality of wells extends into a corresponding hole of the plurality of holes.

7. The reinforced microplate according to claim 6, wherein the portion of the deck at a periphery of the opening of the at least one well of the plurality of wells extending into the corresponding hole of the plurality of holes forms a well opening periphery located on an opposite side of the reinforcing member from a remaining portion of the at least one well.

8. The reinforced microplate according to claim 1, wherein the reinforcing member comprises a plurality of first fixing structures and the deck comprises a plurality of second fixing structures configured to engage with the first fixing structures.

9. The reinforced microplate according to claim 1, wherein the deck comprises a plurality of first fixing structures and the reinforcing member comprises a plurality of second fixing structures configured to engage with the first fixing structures.

10. The reinforced microplate according to claim 1, wherein the microplate main body comprises polypropylene.

11. The reinforced microplate according to claim 1, wherein the reinforcing member comprises a material chosen from glass, copolymer blends, copolymer resins, glass-filled polypropylene, mineral-filled polypropylene, polysulfone, polyphenylene sulfide, polycarbonate, a mixture of acrylonitrile butadiene styrene with polycarbonate, and a mixture of polybutylene terephthalate with polycarbonate.

12. The reinforced microplate according to claim 1, wherein the microplate main body comprises an optically transparent material.

13. A method of forming a reinforced microplate, comprising:
providing a microplate main body comprising:
(1) a deck comprising a first surface and a second surface, and
(2) a plurality of wells,
wherein each well of the plurality of wells extends from the second surface in a substantially perpendicular direction, and
wherein each well comprises an opening on the first surface; and
engaging a reinforcing member to at least one surface of the deck.

14. The method according to claim 13, wherein providing a microplate main body comprises forming a microplate main body.

15. The method according to claim 14,
wherein the microplate main body comprises polypropylene, and
wherein the reinforcing member comprises a material chosen from glass, copolymer blends, copolymer resins, glass-filled polypropylene, mineral-filled polypropylene, polysulfone, polyphenylene sulfide, polycarbonate, a mixture of acrylonitrile butadiene styrene with polycarbonate, and a mixture of polybutylene terephthalate with polycarbonate.

16. The method according to claim 14, wherein the engaging comprises welding, riveting, heat staking, cold forming, ultrasonic staking, swaging, snap-fitting, or over-molding.

17. The method according to claim 14, wherein the reinforcing member comprises a plurality of holes corresponding to the plurality of wells, and
wherein the engaging comprises affixing at least a portion of a periphery of at least one hole of the plurality of holes to at least a portion of a periphery of the opening of a corresponding well of the plurality of wells.

18. The method according to claim 14, wherein the microplate main body is over-molded on the reinforcing member, or wherein the reinforcing member is over-molded on the microplate main body.

19. A reinforcing member configured to attach to a microplate main body comprising a plurality of wells, said reinforcing member comprising a plurality of holes corresponding to the plurality of wells.

20. The reinforcing member of claim 19, wherein said reinforcing member comprises a material chosen from glass, copolymer blends, copolymer resins, glass-filled polypropylene, mineral-filled polypropylene, polysulfone, polyphenylene sulfide, polycarbonate, a mixture of acrylonitrile butadiene styrene with polycarbonate, and a mixture of polybutylene terephthalate with polycarbonate.
